(19) United States
(12) Patent Application Publication
(10) Pub. No.: US 2009/0204718 A1
(43) Pub. Date: Aug. 13, 2009

(54) USING MEMORY EQUIVALENCY ACROSS COMPUTE CLOUDS FOR ACCELERATED VIRTUAL MEMORY MIGRATION AND MEMORY DE-DUPLICATION

(76) Inventors: Kevin P. Lawton, San Francisco, CA (US); Stevan Vlaovic, San Carlos, CA (US)

Correspondence Address: Shemwell Mahamedi LLP;Suite 201, 4880 Stevens Creek Blvd., San Jose, CA, 95129, US

(21) Appl. No.: 12/368,247

(22) Filed: Feb. 9, 2009

Related U.S. Application Data
(60) Provisional application No. 61/027,271, filed on Feb. 8, 2008.

(51) Int. Cl. G06F 15/16; G06F 12/08

(52) U.S. Cl. 709/230; 711/6; 711/E12.016

(57) ABSTRACT

A memory state equivalency analysis fabric which notionally overlays a given compute cloud. Equivalent sections of memory state are identified, and that equivalency information is conveyed throughout the fabric. Such a compute cloud-wide memory equivalency fabric is utilized as a powerful foundation for numerous memory state management and optimization activities, such as workload live migration and memory de-duplication across the entire cloud.

### CROSS-REFERENCE TO RELATED APPLICATIONS

This application claims priority of U.S. Provisional Patent Application No. 61/027,271, filed Feb. 8, 2008.

### FIELD OF THE INVENTION

The present application relates to the field of memory state management in networked computer systems and more particularly using memory equivalency discovery throughout networked computer systems for Virtual Memory migration acceleration and memory de-duplication.

### BACKGROUND OF THE INVENTION

As computer processing capacity grows exponentially, density of software tasks on any given compute cloud (an arbitrarily large set of networked computer systems) also grows significantly. This growth of density is exacerbated by the advent of virtualization on commodity computer hardware; virtualization allows multiple virtual operating system instances to run on a given physical computer system. As a result, there is an increasingly significant amount of duplicate computer memory state (defined as contents of computer physical memory or similar hardware facility) across computer systems in any given compute cloud, due to commonality of applications, libraries, kernel components, and other common software data structures.

Such redundancy of memory state potentially impedes the ability to achieve further compute densities, especially as in practice as virtualization servers often become memory constrained before they become compute constrained. A virtual machine (VM) architecture logically partitions a physical machine, such that the underlying hardware of the machine is time-shared and appears as one or more independently operation virtual machines, each an abstraction of an actual physical computer system. Lack of density of Virtual Machines (VM)s or other type of software work (often referred to in the current art as workloads) which can run on computer systems necessitates a greater amount of physical memory and computer resources, which has many resulting disadvantages, including a greater amount of overall power consumption, capital expense costs, greater floor and rack space demands, human resources, etc. Random Access Memory (RAM) and other forms of physical memory are significant contributors to power consumption in data centers and to computers in general. Additionally, lower VM density is disadvantageous, as there is inherently an initial cost of powering on all of a given computer system's circuitry to run the first VM, and only incremental costs in powering on and running further VMs. Therefore, the more VMs or other workloads which can be run on any given computer system, the more the initial power-on costs are amortized (across a given physical compute device). Thus, the ability to increase VM density for a given set of compute resources can yield a substantial savings in power consumption, and reduce the amount of compute resources needed.

Current virtualization solutions reduce only a small fraction of the existing memory state redundancy throughout a given compute cloud; they offer the ability to de-duplicate such redundancy within the confines of a single computer system or singular node on the compute cloud. This has not only the disadvantage of a constrained amount of potentially redundant memory to reduce, but also is widely subject to variations of the similarities in workloads which are executed on a given computer system at any given time.

According to the current art, VMs can be migrated across a network from one server to another, while retaining the appearance of continued execution, often referred to in the current art as live migration (live indicating that the VM does not need to be halted or suspended). The entire process of VM live migration often requires on the order of minutes to complete, depending on the size of the VM memory state and performance characteristics of the network. This lengthy VM migration time affects the ability to move VMs away from failing computer equipment, the ability to migrate a large number of VMs to another geographic location (e.g. in case of local power outage or crisis) and the ability to load balance VMs across a given set of computer resources when workload utilization spikes occur. The larger the number of VMs which need to be migrated and the lower the performance characteristics of the networking infrastructure used to migrate VMs, the more problematic lengthy VM migration times become. When scaling VM migration for crisis or load management to a geographically dispersed multi data center level, lengthy VM migration can quickly become untenable and require more networking capacity than a given infrastructure possesses. There simply is not enough time and networking bandwidth to migrate such large quantities of VM memory state. For these reasons, VM migration does not scale well past a Local Area Network (LAN).

Many virtual and physical computing systems, rather than read and write directly to individual disk drives, use a Storage Attached Network (SAN) or other storage fabric as a replacement for local disk drives. While current storage solutions provide mechanisms for storage de-duplication and cross site acceleration, they are not well suited for handling memory state optimizations across a compute cloud (such as VM migration), for a variety of reasons. First, at the time of an operation such as VM migration, the enabling system must already know of memory state transfer optimization potentials, in order to accelerate the migration operation. It is a performance impediment in this case, to first necessarily write memory contents of a given VM to the central storage system only to then process optimization potentials at the storage level, before then effecting memory state migration optimizations. Second, contents of computer memory state are often transient and subject to rapid change as various software tasks start and complete frequently. Additionally, some memory state can never viably participate in compute cloud memory equivalency optimizations, and can be observed as such before any further resources are utilized. Third, computer memory state can hold information (e.g. a password) which was never intended to be persistently stored (such as, to disk) in any form, or information which has unknown data retention policy. Fourth, with virtualization, since many VMs run concurrently on a given server, many memory state equivalency opportunities exist on a given server without necessitating communications through a storage or other type of network. Observing and taking advantage of such local opportunities is advantageous to achieving more efficient VM migration and other memory state equivalency based optimizations given the volatility of memory state, while reducing network traffic.

### BRIEF DESCRIPTION OF THE DRAWINGS

FIG. 1 is a high-level illustration of VM memory state sharing across physical servers, according to various embodiments of the invention.

FIG. 2 illustrates VM memory state equivalency and signing (based on a signature) on a more extended compute cloud, according to various embodiments of the invention.

FIG. 3 illustrates a signature entry representing the storage for meta-level information about potentially equivalent memory state, according to various embodiments of the invention.

FIG. 4 illustrates how a section of memory state is signed using a signature entry and stored into a signature database, according to various embodiments of the invention.

FIG. 5 is a flowchart illustrating a method for matching sections of memory state, according to various embodiments of the invention.

FIG. 6 is an illustration of the spectrum of time frames when memory state signing or matching occurs, according to various embodiments of the invention.

FIG. 7 is a block diagram of probability based seeding of memory state signing, according to various embodiments of the invention.

FIG. 8 illustrates a multi-way memory state compare, according to various embodiments of the invention.

FIG. 9 is a block diagram illustrating details of an exemplary memory state database, according to various embodiments of the invention.

FIG. 10 illustrates a super section entry which represents the signing of multiple aggregated memory state sections, according to various embodiments of the invention.

### DETAILED DESCRIPTION OF THE PREFERRED EMBODIMENTS

Various embodiments of the invention include systems and methods which create a memory state equivalency analysis fabric which notionally overlays a given compute cloud; equivalent and potentially equivalent sections (defined as a sequence of memory contents in computer RAM or other similar physical computer memory) of memory state are identified, and that equivalency information is at times conveyed throughout the fabric. Such a compute cloud wide fabric is a powerful foundation for numerous memory state management and optimization activities.

One exemplary optimization activity, detailed in embodiments herein, is acceleration of memory state transfer within a VM live migration. Various embodiments exploit the memory state equivalency fabric in order to transfer much less VM memory state, in cases where various sections of VM memory state can be more optimally transferred to the destination of a VM migration from other equivalent sources, or where equivalent memory sections already exist on the destination. As the size and network topology of any given compute cloud grows, the time and network distance between extremes of the cloud grows, as does the worst case transit time of an non-accelerated VM migration. Various embodiments allow VM live migration to scale to a much larger and more dynamic compute cloud.

A second exemplary optimization activity, also detailed in embodiments herein, provides memory state de-duplication at the compute cloud scale. This optimization exploits the memory state equivalency fabric to discover redundancy across the vast reservoir of memory state of a given compute cloud, and de-duplicate various memory state. The result of memory state de-duplication is a significant reduction in the physical memory requirements of a compute cloud, and an increase in the ability to fully task computer systems in the compute cloud, which are often RAM constrained in practice, according to various embodiments.

According to some embodiments, memory state equivalency mechanisms and optimizations operate on active, fully loaded computer systems which volatile and dynamic workloads.

Various embodiments provide a memory state equivalency fabric for ad-hoc compute clouds whereby computer systems can join (or leave) dynamically and begin participating almost instantly in the memory state equivalency fabric and participate in related optimizations such as live migration acceleration. In some live migration scenarios, participating computer systems, even if not the source or destination of the migration, can be of great benefit to the operation, based on their relative proximities to the migration destination and memory state content, according to some embodiments.

Various techniques are disclosed, including a combination of memory state signing, also called memory state fingerprinting herein, and methods to disambiguate otherwise possibly non-equivalent memory state with similar fingerprints. Memory state signing allows for an efficient mechanism to identify potentially equivalent memory state across an arbitrarily large compute cloud, and as a basis to further identify memory state to be truly equivalent, when combined with other techniques. Embodiments provide a mechanism to attribute memory state within various domains, such as security, locality, or work-groups, with uniqueness identifiers, such that memory state is guaranteed to be equivalent within such domains for equivalent fingerprints. With equivalence guaranteed, all similarly attributed memory state, regardless of its location, can be used, potentially without re-comparing, to facilitate and optimize various memory state management activities. For example, in live migration of VMs, embodiments allow for significantly less memory state to be migrated between source and destination systems, if memory state in common is determined to already exist at or near the destination of the live VM migration.

Memory state signing, in various embodiments, involves the creation of various levels of signatures for various portions of memory state. Mechanisms are provided, to determine which portions of memory state should be examined for equivalence with other known memory state. In various embodiments, signatures may be non-unique, as is a common potential of using hash functions to sign any data, or from signing only part of a memory state in question. In such cases, non-equivalent memory state may potentially map to the same signature. In other embodiments, signatures may be guaranteed to be unique, by way of extending the signature with uniqueness, coordinated throughout some part or all of a signatures database. In yet other embodiments, a mixture of unique and non-unique signatures may be used. Signatures are generally much smaller in size than the actual memory state which they sign. The compact size of the signature allows for efficient comparisons and lower signature storage requirements, while the uniqueness of certain signatures allows for the guarantee of memory state equality given equal signatures, within a given domain. In some cases, optimizations can be made, which trade off uniqueness for performance in either generating the signature or comparing signatures. As is further described herein, various embodiments include systems and methods for supporting a signatures database. The database may be centralized, distributed, hierarchical, or any combination thereof.

In various embodiments, a signature can optionally include a reference to the actual memory state, such that memory state management activities may be optimized to only involve passing or manipulation of the reference. As is further described herein, some embodiments of the invention include systems and methods for supporting a memory state database, which may be centralized, distributed, hierarchical, or any combination thereof. In some embodiments, with a memory state database, migration, for example, involves copying of the reference to the original memory state, and increasing the reference count within the memory state database.

In some embodiments, multiple memory state sections can be signed and operated on in an aggregated fashion to further optimize memory state activities. For example, a number of memory state sections may represent a code segment of an Operating System (OS), which may be aggregated into a single large section for simpler or more efficient comparisons; memory state migration would then require less transmitted information for the participating sections. In various embodiments, such aggregation can be done for memory state which is sequential or continuous at a higher level, for example at a virtual memory address level for VM memory state, even though it is not necessarily sequential or continuous at a lower level, such as at a physical memory (RAM) address level.

In some embodiments, signatures of memory state may be incomplete to allow for faster comparisons. In this type of environment, the number or fidelity of comparisons can be gradually increased to achieve more accuracy to the potential detriment of increased processing (i.e. comparison) time. In various embodiments, comparison of signatures may occur off-line (when a VM is suspended), just before loading a VM, or dynamically at run-time.

Some embodiments provide a mechanism to divide a network of compute resources (e.g. a compute cloud) into various domains with respect to uniqueness of signatures. Domains may be associated with physical or topological network boundaries in some embodiments. In other embodiments, domains may be purely notional, such as those used for workgroups or security attributes. Domains also serve to reduce compute and networking loads associated with proving equivalence of memory state.

According to various embodiments, memory state is signed, further deemed equivalent to other equivalent memory state, and optimized on a basis of sections. Generally, the size of a section is chosen based on the size of a computer system's virtual memory page size (e.g. 4096 bytes on Intel IA32 processors).

In order to accomplish memory state management activities which leverage equivalency as a basis, an efficient method for recognizing potentially equivalent memory states, and for comparing those states, is implemented. A signature is defined as an identifier or compact representation of a portion of memory state. In certain embodiments, commonly utilized methods herein for signing memory state are hash functions, and various forms of checksums. When such methods of signing are utilized in various embodiments, resultant signatures are potentially non-unique, in that two non-equivalent memory states may produce the same signature. In some embodiments, the generation of signatures may be a progression, starting with the signing of less of the memory state in question or using smaller or weaker signature methods (i.e. more non-uniqueness among signatures), and progressing towards the signing of more of the memory state in question or using larger or stronger signature methods. The progression of a signature may involve incrementally extending the size and strength of the signature, adding multiple signatures, or replacing the previous signature. At times, in various embodiments, it is determined that a given memory state is worthy of creating an unambiguous signature, which is guaranteed to represent only the memory state which it signs. When this occurs, the signature is extended or replaced with a unique identifier, which is orchestrated throughout part or all of the signature database, in certain embodiments. When the signature database contains entries that potentially match a given memory state's ambiguous signature, in some embodiments, the progression of signatures is advanced until a full memory state compare is deemed productive. Ultimately, a fully disambiguating memory state condition is achieved or a disambiguating operation is invoked on two or more potentially equivalent memory states, on any number of hosts, according to various embodiments. In one embodiment, a full memory compare is used to disambiguate memory state. In other embodiments, one or more hashes is deemed dependable enough to discard potential ambiguity. According to various embodiments, a full state memory compare may be done on one host, or on any number of hosts and database components using a multi-way compare. Upon a successful compare of two or more memory states, a signature uniqueness method is invoked to give a guaranteed unambiguity to the signatures representing equivalent memory states. Thereafter, memory states on participating hosts which are marked with equivalent and unambiguous signatures are known to be equivalent by way of simple signature or unique ID compares. In various embodiments, ambiguous and unambiguous signatures are stored in separate databases. In other embodiments, they are stored in a combined database. Uniqueness identification information is often communicated and orchestrated throughout the database components of some or all participating domains. In one embodiment, an incrementing counter maintains the next available uniqueness identifier which when applied to a signature is used to guarantee equivalence between multiple sections of memory state when they are signed by equivalent signatures. In a second embodiment, incrementing counters are similarly implemented, however orchestration of allocating next available uniqueness identifiers is done in a distributed fashion with sub-ranges of the identifier space parceled out amongst various participating components of the database. In a third embodiment, a centralized or distributed sparse pool is utilized to allocate next available uniqueness identifiers; as identifiers are used, they are marked as such in the pool, and as they become unused, they are returned to the free portion of the pool.

Optionally, the raw memory state information may be stored in a state database, at the section level granularity. For example, the memory state representing the running workload may be stored in the state database which may be centrally located, distributed, hierarchical, or any combination thereof, according to various embodiments. In one embodiment, the memory state database is comprised of only the standard memory in the collection of networked computer systems; no additional database is used, but rather the existing aggregate compute cloud physical memory and operating systems can be thought of as a distributed memory state database.

As explained further herein, a memory state database has significant advantages. In order to migrate a running VM across a Wide Area Network (WAN), for example, it is not required for all of the VM memory state to be transferred to the target node, as is the case in the prior art. Rather in one scenario where equivalent memory state exists on both source and destination of a VM migration, much smaller references to the equivalent VM memory state are passed to the destination in lieu of actual memory state, according to some embodiments. Or in another scenario, equivalent memory state is transferred to the migration destination from sources closer to the destination, according to some embodiments. In various embodiments, any memory state typically managed by computer systems, may participate as part of the state database.

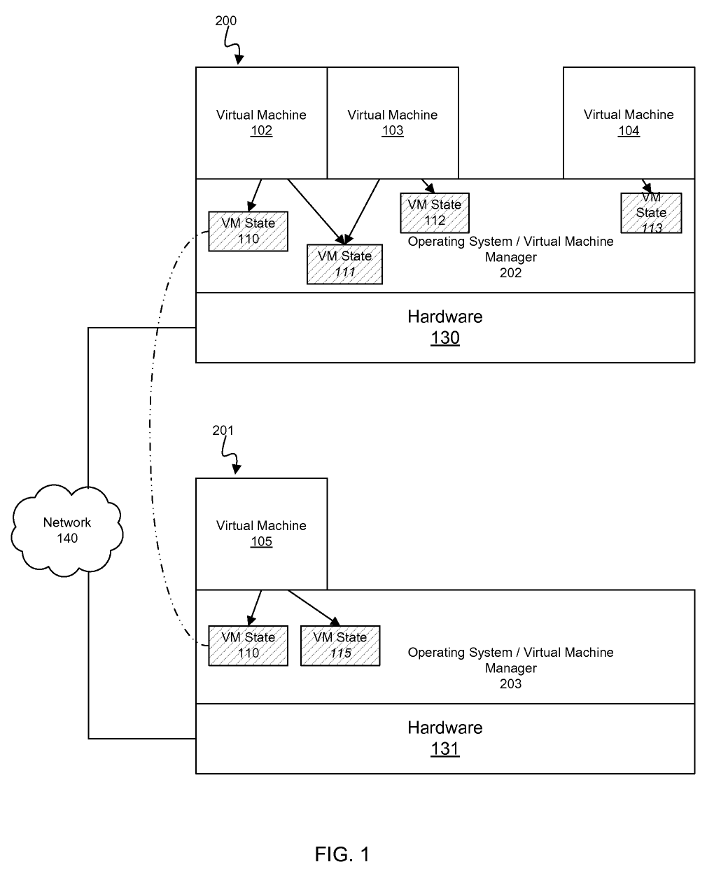

FIG. 1 is a high-level illustration of VM memory state sharing across physical servers, according to various embodiments of the invention. Computer systems 200 and 201, exemplify two computer systems which run a virtualization hypervisor (an OS which runs VMs) and a number of VMs, on hardware 130 and 131. In such an arrangement, the collective system comprised of the hardware and the hypervisor is often referred to in current art as a host system or host, because it hosts other VMs. Similarly, the hypervisor is often referred to in current art as a host OS. Host environments 200 and 201 are each comprised of hardware, a number of VMs, and a host OS which manages the VMs and their corresponding memory state.

Hardware 130 and 131 include, for example, integrated circuits, network devices, input and output devices, storage devices, display devices, memory, processor(s), or the like.

Host OS 202 runs on hardware 130, and similarly host OS 203 runs on hardware 131. In some embodiments, each host OS manages the execution and state of a number of VMs which run on the corresponding host OS. VM state may be comprised of data, disk storage, or other forms of state needed to manage and provide for the execution of the VM. As illustrated, host OS 202 manages VMs 102, 103, and 104, and their respective quantities of memory state 110 through 113, while host OS 203 manages VM 105 and its two quantities of memory state 114 and 115.

Network 140 connects hosts 200 and 201. Although the exemplary system provides networking capabilities between the hosts, the prior art does not provide any means for ad-hoc memory state sharing and management across networked hosts.

As illustrated, host OS 202 and 203 may each be a typical OS with a built-in VM manager such as RedHat with Xen built-in, or alternatively, a purpose built VM hypervisor such as VMware's ESX platform. However, in various embodiments, a host OS may be any form of OS, executive, software, firmware, or state machine which manages memory state, including those which do not support virtual machines. For example, a commodity OS extended with various embodiments, can optimize memory state management of various workloads such as programs or processes. However, description herein often interchanges use of the word VM and workload, as they are similar in concept, and hence can leverage the benefits of memory state sharing.

In FIG. 1, VM 102 on host environment 200 is illustrated to show that it shares VM memory state 110 with VM 105 on host 201. VM memory state 111 is illustrated to show sharing between VMs 102 and 103 on the same host. According to various embodiments of the invention, memory state may be shared and managed across an arbitrarily large network of hosts or other computer systems, within a given host or computer system, within domains within one or more hosts, or temporally for given VMs.

Throughout a compute cloud, there is generally a lot of equivalent VM memory state which can be discovered and used for memory state optimizations. Equivalent VM state may represent a section of a common OS or application, for example. VMs generally have many, differing memory state sections. For example, VM 102 is comprised of memory state 110 and 111. With any degree of memory state sharing (which is significant in practice), the total physical memory (e.g. RAM) requirements in aggregate across hosts in the compute cloud is reduced.

The sharing of memory state potentially increases the complexity of host OS 202 and 203, with the benefit of greatly increasing the performance of memory state management activities such as compute cloud memory de-duplication and VM live migration. For example, live migration of VM 102 from host 200 to host 201 would involve migration of unshared memory state, and potentially migration of only meta information relating to known shared memory state, without the need for the actual shared memory state data to be migrated, thus significantly reducing the amount of data transferred through network 140, accelerating migration time.

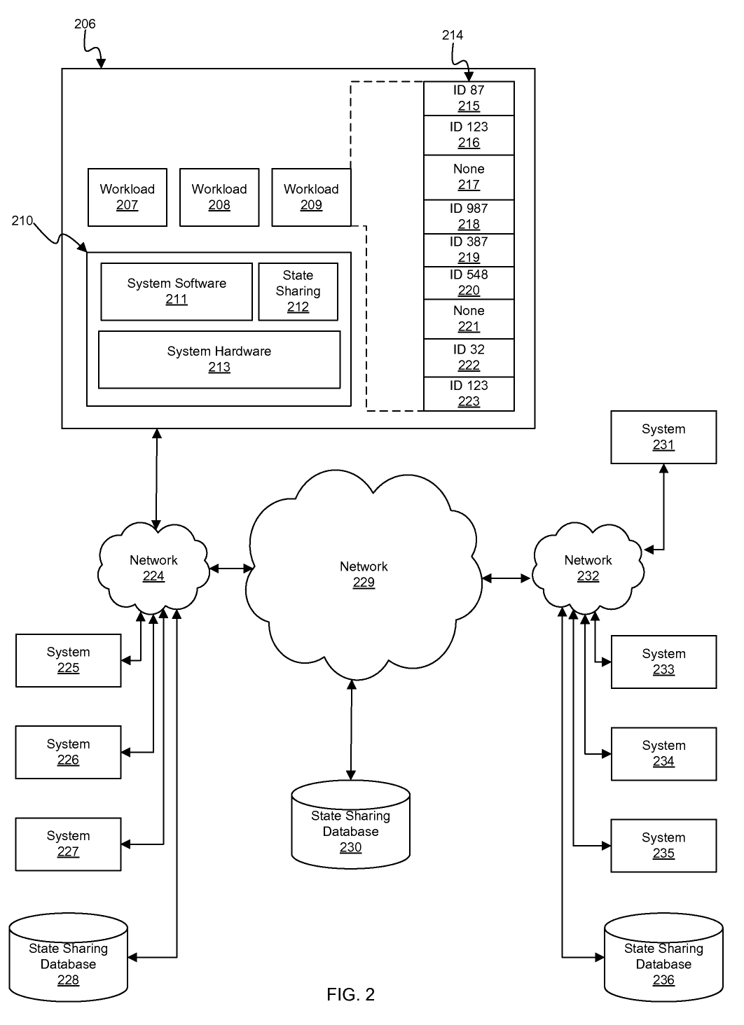

FIG. 2 illustrates a more expansive compute cloud and memory state databases, some or all of which participate in memory state management, according to various embodiments of the invention. Computer system 206 operates much like host 200, and is comprised of base system 210, and a set of workloads 207-209. The base system is comprised of system software 211, analogous to host OS 202, hardware 213, analogous to hardware 130, and memory state sharing module 212. State sharing module 212 interfaces with the base systems, and manages the signature and memory state database activities, according to various embodiments. In some embodiments, state sharing module 212 is actually integrated into system software 211. Each software workload can be a VM, an application, a program or process, or any other type of compute work, as further described herein. Expanded view 214 illustrates the tracking of various sections of memory state within workload 209, according to various embodiments. As illustrated, some of the sections of memory state have been signed (i.e. have signatures), while other sections have not yet been signed. For example, sections 217 and 221 have not been signed, and correspondingly labeled “none”, as no signature identifier has been generated. The other illustrated sections 215-223, have been signed, and are shown with various signature identifiers, which have been simplified for the purposes of illustration.

A number of other computer systems, similar in function to computer system 206, are illustrated, such as systems 225-227, 231, and 233-235. The systems are connected via a topology of networks, with local networks 224 and 232, and a greater area network 229.

As illustrated, memory state sharing databases 228, 230, and 236, are also attached to the network. In various embodiments, separate databases may participate in storage and retrieval of memory state and signatures, as an adjunct to, or in replacement of equivalent functionality in the participating computer systems. Storage of memory state and signatures throughout the network, can be thought of as a single database, and sometimes generically referred to herein as the database, the memory state database, or the signature database. According to some embodiments, memory state and signatures are maintained separately. In other embodiments, memory state and signatures are maintained together within the same structure or structures. In yet other embodiments, memory state and signatures are stored together in some database components, and stored separately in other database components. Storage of information within the database, in some embodiments, is exclusive, in that any given piece of information is actively stored in only one component of the database. In a second embodiment, storage of information is inclusive, and as such a given piece of information may be actively stored in more than one database component. In a third embodiment, a combination of inclusive and exclusive storage is used across various components of the database.

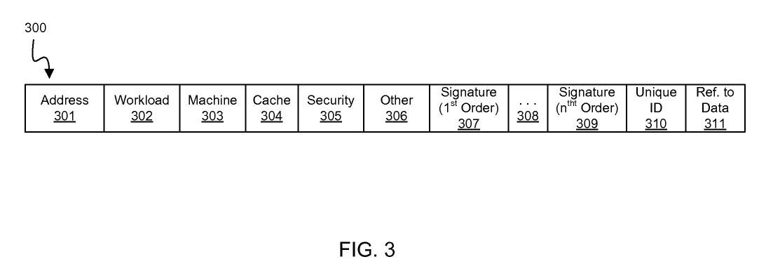

FIG. 3 shows an exemplary signature entry 300 for holding meta-information for each section of signed memory state, such as VM memory state 115, according to various embodiments of the invention. Host OS 202 and 203 need to have a mechanism for tracking VM memory states to be able to compare, copy, and manage them. Each portion of signed VM memory state, such as VM memory state 115, requires at least one signature entry. Typically, the signature entry represents a section of memory state of size that is defined by the hardware, such as a virtual memory page, as is the case in various embodiments. But as is described further herein, signatures may refer to larger structures which span more than one such quantity.

Typically, address 301 includes information regarding the particular physical memory page on hardware 130 and 131 where the VM memory state natively resides, which may or may not be a complete physical memory page address. Workload 302 identifies the particular workload or VM, to which the state belongs, for embodiments in which this needs to be specified explicitly. Various embodiments of the invention have provisions for supporting memory state management across multiple computer systems, which is the purpose of machine ID 303. Machine ID 303 uniquely identifies the machine or host in a group of one or more machines or hosts, according to various embodiments.

In addition to uniquely identifying a section of VM memory state, other meta-information may be required. For example, in some embodiments, provisions for noting or partitioning by cache domain or security domain may be required, utilizing fields cache 304 or security 305. Similarly, for future tracking of VM memory state, field other 306 may be used to extend the capability of signature entry 300.

Signature (1^{st} order) 307 through signature (n^{th} order) 309 illustrate the signature field data, used as a compact representation of the actual memory state data. As is described herein, in various embodiments, the signature can be extended in size or quality in a progression, until it is determined that the state in question is worthy of generating a unique signature that guarantees equivalency. In such embodiments, the illustration shows extra fields to accommodate the signature progression, by way of extension or replacement, at each extension iteration. In some embodiments, there is only one fixed-width signature field.

Unique ID 310 is a field, which in some embodiments, extends an ambiguous signature, to be unambiguously equivalent to other memory. In other embodiments, some or all of the signature field(s) are replaced with a uniqueness value. The uniqueness value is coordinated throughout part or all of the participating hosts in the signature database. As is described further herein, various embodiments have a mechanism for adding such uniqueness which is network-wise topologically aware. This allows for comparisons to be done, for example, first within sub-domains of a network before then comparing between sub-domains within a broader network topology. Such a hierarchical strategy eliminates network traffic and optimizes the analysis of memory state equivalency throughout a compute cloud.

Optionally, each signature entry may have a reference to data 311 field, according to various embodiments of the invention. The reference to data field identifies the location of the memory state referenced by the signature entry.

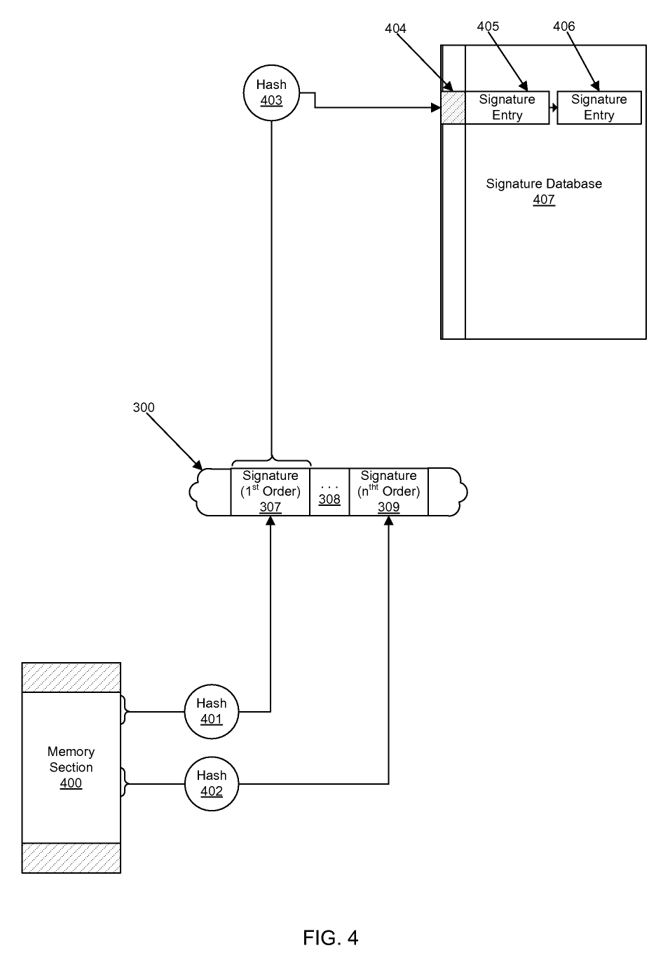

FIG. 4 illustrates how a section of memory state is signed using a signature entry 300 and stored into a signature database, according to various embodiments of the invention. For example, memory section 400 is a physical memory page on hardware 130, which in some computer systems is 4 KB in size.

Memory section 400 is initially signed using hash 401 to produce signature (1^{st} order) 307. Optionally, signature 307 may be further hashed using hash 403, in order to generate an index 404 into the signature database 407. In various embodiments, signature 307 may be solely used to index into the signature database, or any other partial or full signature or hash thereof may be used. The signature entry, when added to the database, is added to the list of entries corresponding to the generated index. For example, signature entry 405 and 406 reside in the list indexed by index 404, as illustrated. Given an index may not be unique to a single signature entry, collisions may occur and are managed by maintaining lists of signature entries for any given index. To perform comparisons between signature entries, an index needs to be generated and the list, if non-empty, traversed, and compared to find matching signature entries. While a list is illustrated, any number of common data structures can be used to manage multiple entries, according to various embodiments. In some embodiments, a progressive signature is used, in which case an effectively wider signature is hashed to perform a lookup into the signature database. As a result, multiple signatures for a given section of memory state may be in the database at one time. In one embodiment, all versions or widths of a signature use the same fraction of the signature, so that all signature entries index to the same location in the signature database. To exemplify, even if all fields signature 1^{st} order 307 through signature n^{th} order 309 are complete, indexing signatures into the signature database may always use only the initial 1^{st} order field. This makes handling multiple signatures for a given section more manageable. But in another embodiment, signature entries are indexed in such a way that signatures may index into entirely different parts of the signature database.

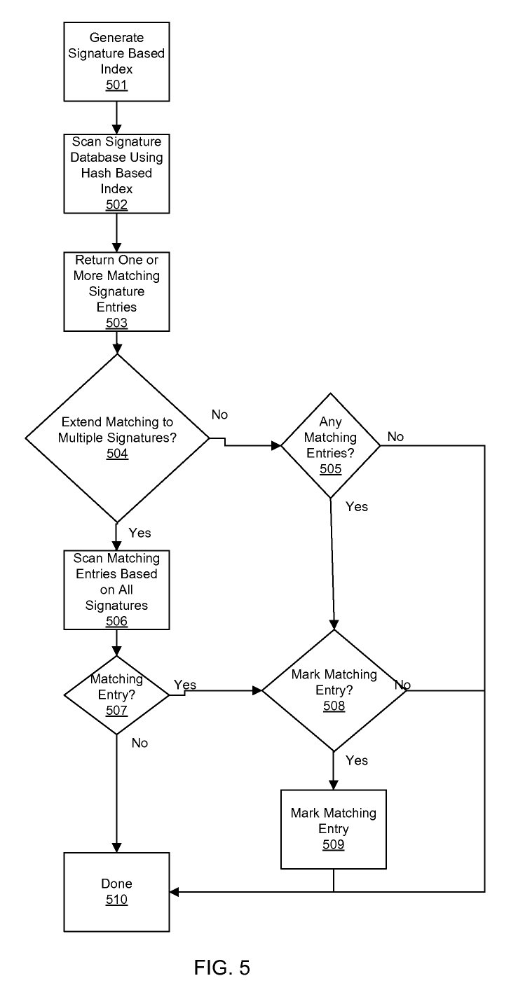

FIG. 5 is a flowchart for matching sections of memory state, according to various embodiments of the invention. The first step is to generate signature based index 501, which is shown in more detail in FIG. 4. Once an index is generated, the next step is to scan signature database using hash based index 502 in order to find matching signature entries. Step return one or more matching signature entries 503 follows with returning the list of signature entries. If there are multiple matching signature entries based on the index, then step extend matching to multiple signatures 504 is used to direct the algorithm to scan matching entries based on more or all signatures 506. If there are less than two signature entries indexed, then step any matching entries 505 is used to determine if there is one and only one matching signature entry. If no matching signature entries are indexed, then processing completes with step done 510.

If there is one and only one matching signature entry indexed, then the algorithm proceeds to step mark matching entry 508 where it is determined whether or not the matching signature entry should be marked as matching with the current signature entry under test. If the signature entry needs to be marked, then processing continues to step mark matching entry 509 followed by step done 510. If the signature entry does not need to be marked, then processing completes with step done 510.

If there are two or more signature entries in the list that have the same index, then processing continues to step scan matching entries based on all signatures 506, where more or all signatures are used for comparison. Optionally, a subset of all signatures can be used for comparison, with all signatures matching implying a guarantee of memory state equivalency. If a single matching signature entry is found in step matching entry 507 then processing continues to step mark matching entry 508 as is described herein. If no matching signature entries are found in step matching entry 507 then processing completes with step done 510.

Subsequent to finding potentially equivalent signatures, various embodiments provide a mechanism to perform a memory state comparison to verify that the memory state represented by the matching signatures is indeed equivalent. Memory state may be aggregated on one computer system or database component within a given domain, and the comparison effected, in one embodiment, using network transports in cases where the data is remote. In another embodiment, a de-centralized or distributed memory state compare is effected, taking advantage of distributed resources and locality of data along with the topology of the networks and computer systems. A byte-for-byte comparison in one embodiment, detects if the states in question are indeed equivalent, according to one embodiment. Alternatively, in other embodiments, equivalency of states on differing computer system and memory state database components can be determined without performing an actual byte-by-bye comparisons, by employing strong hash techniques and challenges, such as multiple-hashes or a distributed Merkle tree. However, at a fundamental level, memory pages for example, are fixed sized anonymous structures with potentially random data, which are non-ideal circumstances for compare-by-hash (copy-less) strategies. Therefore, compare-by-hash strategies are best applied when larger or higher level structures in memory can be recognized and signed, such as parts of a program or library or OS kernel, as is the case in certain embodiments. In such cases, the resulting state is larger, often variable length, and sometimes can be named. Naming, according to various embodiments, is a technique of extracting a name of a higher level construct such as a program name, associated with a given memory state, and applying the name to the state. In some embodiments, other kinds of names can be generated by observing a user name, user ID, machine name, or other attributes. Factoring in a name and variable length of related data structure, strengthens many compare-by-hash algorithms. Various embodiments store the synthetic name as part of signatures or generate them before or during state comparison.

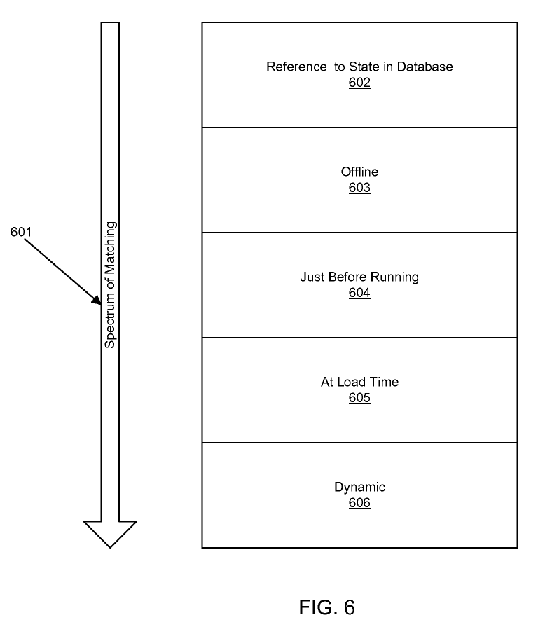

FIG. 6 is an illustration of the spectrum of time frames when memory state signing or matching can occur, labeled spectrum of matching 601, according to various embodiments of the invention.

Reference to state in database 602 shows the case where some memory state is represented by meta-information, and references to memory state that resides in a state database, i.e. memory de-duplication has already occurred. For memory state which is in the state database, comparisons and memory state optimizations can be made by acting on the state database directly.

Step off-line 603 occurs when signature population and matching for the memory state associated with a given VM, are performed when a VM is suspended, off-line or inoperable. Memory state for VMs are frequently stored on more permanent storage (e.g. disk) during these times, therefore the state can be signed and matched by the host OS or an agent thereof, without execution or direct management of the VM.

Just before running 604 population and matching occurs in a similar fashion as off-line 603, except that signature database population and matching for the memory state associated with a given VM, occur at the moment before the VM is brought on-line.

Similarly, at load time 605 signature population and matching is performed while a VM is being loaded into memory.

Dynamic 606 signature population and matching is performed after a VM has been loaded and is currently executing or being directly managed. As the VM executes, the host OS and the databases coordinate likely parts of the VM memory state to be signed and matched versus other memory state.

In any mode 602 to 606, when memory state equivalency is determined in a given VM, various memory state management optimizations can be invoked by the host, such as, but not limited to, memory sharing, accelerated live migration, and others detailed herein.

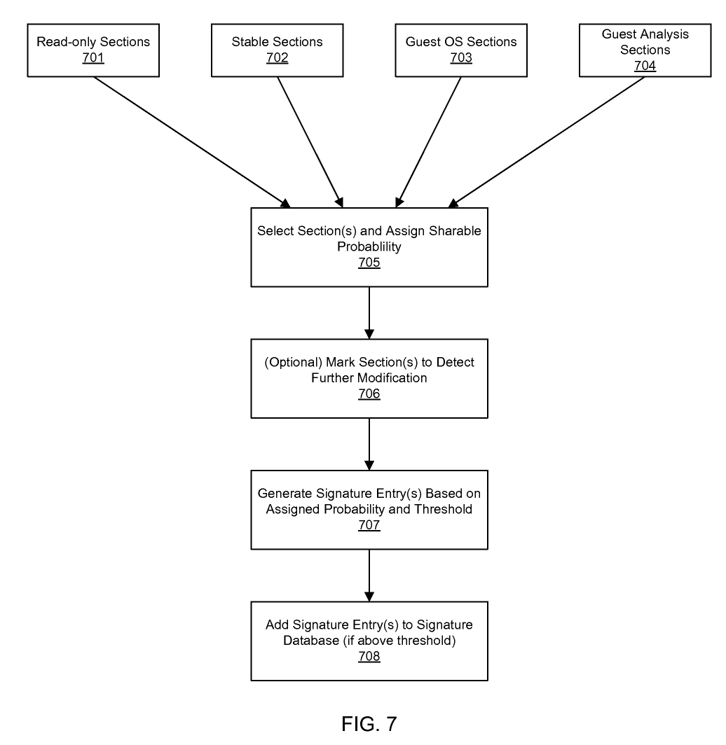

FIG. 7 illustrates an exemplary signature database population method, according to various embodiments of the invention. A number of inputs may be used to determine which memory state should be signed and further assigned guaranteed equivalency. Also illustrated, is an exemplifying sequence in which memory state is selected to be signed and entered into the database, according to one embodiment. Other methods of selecting sections to sign and populate into the database may be used, including arbitrary selection, according to various embodiments.

Read-only sections 701 are often good candidates for memory state sharing, as they are not likely to change. When read-only sections of memory state are also marked with execute attributes by the memory management system or OS, such sections likely contain executable code or other data structures which are likely to be replicated on other machines and thus are potentially equivalent.

Stable sections 702 are sections of memory state which are observed to receive changes with a low rate of periodicity with respect to other sections. In some embodiments, fields in the hardware memory management system and OS environment may be utilized to observe changes to sections of memory state.

Guest OS sections 703, are sections of memory state which can be determined to belong to a guest OS, rather than guest applications, within VMs. As the same guest OS may execute within a number of VMs, such sections may have a higher probability of equivalency potential.

Guest analysis sections 704 are memory state sections in which higher level constructs of a guest OS and applications can be observed by examining structures within the VM, using either an external mechanism available to the host OS, or an agent within the guest OS. For example, if the process tables of an OS within a VM, can be observed, it is possible to recognize such constructs such as an application or process, including the application name, attributes, and state usage. With such visibility, especially across multiple VMs, very large sections of memory state can be recognized as potentially equivalent.

In various embodiments, sections are selected using one or more of the methods as outlined in FIG. 7, and in some embodiments, a corresponding equivalency or shareable probability is assigned, as is illustrated in select section(s) and assign sharable probability 705.

In some embodiments which provide a method for detecting subsequent modifications to the memory state sections, the sections may be optionally marked to enable such detection, as in mark section(s) to detect further modification 706. When modifications are detected, either the signature entries can be removed from the signature database, or later re-validated as necessary.

Signature entries are then generated, as illustrated in generate signature entry(s) based on assigned probability and threshold 707. In some embodiments, the extent and number of signature entries is based on the assigned sharable probability. In other embodiments, a threshold may determine the number of signature entries. In further embodiments, a different threshold may be used to screen lower probability signatures from being added or promoted in the signature database.

Generated signature entries are then added to the signature database, as illustrated in add signature entry(s) to signature database (if above threshold) 708. In various embodiments which have a mechanism to specify a threshold of shareability, only those signatures which exceed the threshold may be chosen to be added to the signature database.

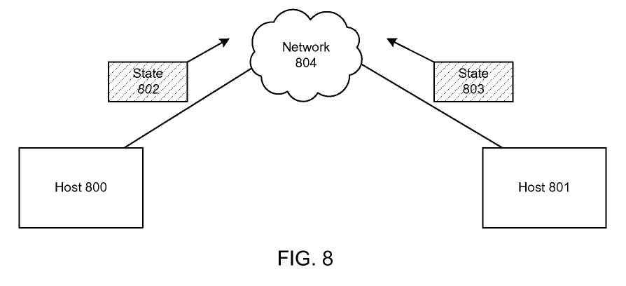

FIG. 8 illustrates a multi-way memory state compare, involving more than one host in a compute cloud, according to various embodiments. At various times, various hosts and database components, determine that two or more sections of memory state may be equivalent, due to a number of possible factors, such as similar signatures. In some embodiments, a full state compare is needed to verify that a given memory state is indeed equivalent to one or more other states in the database. When the memory state resides on different hosts, a multi-way compare can be effected. In a multi-way comparison, various participants in the memory state database send pieces of the state in question, to other participants, to be compared, while retaining the pieces of state which are to be compared locally. Which pieces of memory state are sent and which are retained, is coordinated, by some or all of the participant hosts. To further illustrate, FIG. 8 shows two hosts, host 800 and 801, connected via network 804. In this example, a two-way compare is orchestrated. Host 800 sends partial memory state 802 through the network to host 801, and host 801 sends partial memory state 803 through the network to host 800. Each host then compares partial memory state, and coordinates the results of the compare with the other host, in certain embodiments. In other embodiments, the results are coordinated back to one designated host. In yet other embodiments, the results are coordinated throughout a combination of participants in the database. While illustrated with a two-way compare, various embodiments allow for an arbitrarily large set of compute and database elements to participate in the comparison. This allows for a distribution of the computational work necessary to perform the compare, in addition to potential to optimize the matrix of available resources, proximities, networking bandwidths, and other factors.

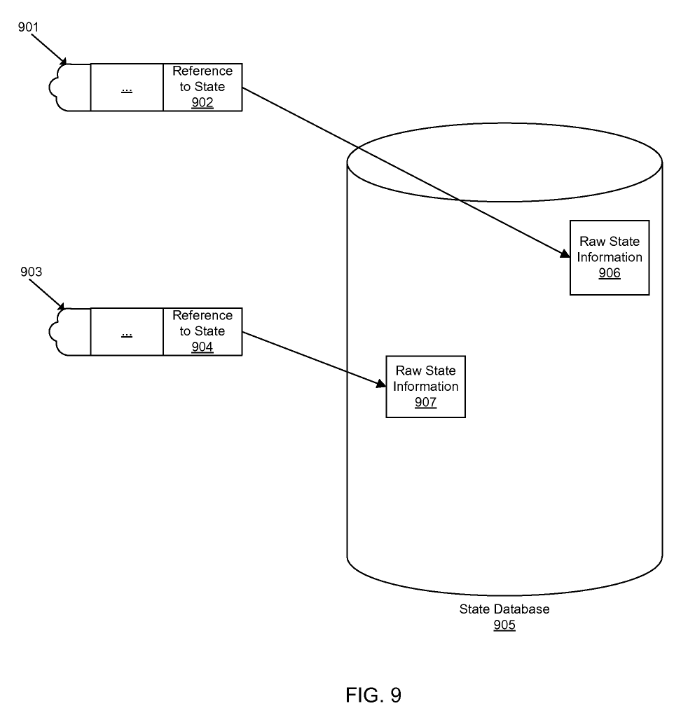

FIG. 9 is a diagram of an exemplary memory state database 905 that contains memory state for select VM sections, according to various embodiments. Signature entries 901 and 903, the format of which is described elsewhere herein, contain a direct or indirect reference to state 902 and 904, which refer to memory state in the state database, in various embodiments. Reference to state 902 refers to raw memory state information 906, and similarly reference to state 904 refers to raw memory state information 907.

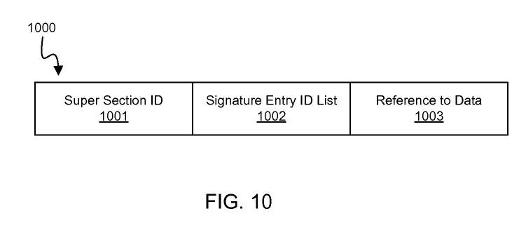

In some embodiments, arbitrarily large groups of signature entries can be tracked as a unit, called super sections, as illustrated in FIG. 10. Super sections provide a mechanism to refer to larger amount of memory state than individual sections, and can be used to optimize the amount of information stored by VMs, and to effect certain memory state optimizations. In some embodiments, super sections may represent multiple pages of memory used by VMs, which are sequential in the virtual address space of the guest OS, even though the pages of memory may be located at arbitrary physical addresses, or at times even swapped out to persistent storage. In various embodiments, data structures used for memory management by the microprocessor and OS, such as page tables on typical x86 compatible microprocessors, are referenced to translate contiguous virtual addresses into non-contiguous physical addresses. In other embodiments, super sections may represent disk blocks loaded into VM memory, which are sequential at the file level of storage, though the disk blocks may be located at arbitrary places in VM memory. In other embodiments, super sections represent clusters of logically related signature entries used by VMs, i.e., those signature entries that belong to the same guest kernel, application, or library. Placing signatures into super sections can be done by way of observation by the host OS, or by one or more agents inside the VMs, in various embodiments.

By being able to refer to super sections, potentially less information needs to be stored or conveyed, optimizing some memory state sharing mechanisms. For example, a migration of a given VM between different machines can be done by conveying less information between the source and destination hosts, if at least some of the memory state of the VM is represented by super sections.

Super section ID 1001 is an identifier in super section entry 1000. In some embodiments, super section ID may be inferred from the storage structure, e.g., by way of an index into a table.

Signature entry ID List 1002 illustrates an arbitrary or fixed sized list of signature IDs. In various embodiments, this list may be implemented structurally as a list, a queue, a stack, a linked list, or other data structure.

In some embodiments, a reference to the memory state data is also stored in the super section entry 1000, illustrated by reference to data 1003. In some embodiments, reference to data 1003 can point to the logical beginning of the VM memory state, and the remaining VM state sections are implied thereafter. In other embodiments, memory state references can also be stored for each signature entry in the list. In further embodiments, no memory state references are stored in the super section, but rather the signature entries are referenced to find memory state information.

For a compute cloud, it may be important to ensure that signatures are propagated to other participants, such that more memory state equivalency can be recognized, and thus an increase in the efficiency of memory state management is enjoyed. To effect this, in some embodiments, agents on the hosts or in the signature database actively push candidate signatures out to other participants. In other embodiments, similarly placed agents pull candidate signatures from other participants. In yet other embodiments, similarly placed agents both push and pull candidate signatures to and from participants in the signature database. With greater visibility, more memory state can be marked as a candidate for a fuller comparison, yielding memory state management optimizations, wherever equivalency is determined.

A greater network context may include any number of sub-networks, including elements of LAN (local-area), MAN (metro-area), and WAN (wide-area) networks. Because the amount of potentially comparable memory state is unbounded, yet various network segments have varying but bounded bandwidths, blindly treating and comparing all memory state as a single domain could be largely inefficient, if not untenable. Various embodiments provide a combination of memory state sub-domains, algorithms and topological awareness to more optimally achieve state management objectives described herein.

In one embodiment, a method is provided for an administrator to manually assign topology information relating to networks, computer systems, databases, and other components of the entire processing fabric. In other embodiments, an algorithmic discovery process determines the topology information. Further embodiments combine manual entry and algorithmic mechanism, including dynamically adapting to topological changes as they occur.

Based on topological information, various embodiments initiate equivalent memory discovery methods, described herein, first within localities of the topology. To exemplify, in FIG. 2, memory state in common between Systems 225 and 227 could be discovered and entered into the memory state sharing database 228, all of which resides on the same LAN. Similarly, memory state in common between Systems 233 and 235 could be discovered and entered into memory state sharing database 236. To reduce the traffic which traverses between networks 224 and 232 through network 229, various embodiments would then discover potentially equivalent memory state between state sharing databases 228 and 236, and subsequently invoke memory state comparisons between databases in the two related sub-domains. Once equivalent memory state is found between sub-domains, in one embodiment the unique identifier from the memory state of one sub-domain is copied to the database of the other sub-domain. Potentially this frees up a uniqueness identifier, in which case an identifier may optionally be recycled to a pool of free identifiers. In another embodiment, a different identifier is assigned and propagated to all relevant memory state sharing databases. Yet other embodiments combine both strategies.

Having known equivalent memory state stored in multiple locations of a given network can greatly optimize many VM management operations. For example, in the case of VM live migration, if a portion of a given VM's memory state is known to be replicated between systems 227 and 233 in FIG. 2, then only the non-duplicated memory state needs to be transferred across the various network components. In place of the duplicate memory state, far smaller signature information is transmitted where possible. If it is known or suspected a priori, that a given VM will be migrated in the future, further optimizations can be realized. In one embodiment, the database can be commanded to start discovering equivalent memory state between a given single or set of VMs and another set of VMs or systems elsewhere. In another embodiment, a mechanism is provided to interact with a VM scheduling or migration agent in order to speculate on potential VM migrations, and thus begin a more focused discovery between source and destination VMs and systems. When a VM migration does occur, much of the common memory state may have been discovered and available for migration acceleration.

Various aspects of the embodiments discussed above are set forth below, without limitations:
Memory state equivalency analysis fabric which overlays a networked compute cloud, and operates on active computer system memory representing live or suspended workloads.
Accelerated live VM (and other forms of workload) migration.
Distributed memory de-duplication throughout a networked compute cloud.
Ability to add or remove compute nodes and database nodes dynamically.
Ability to more proactively track equivalency between given workloads when a migration is possible or anticipated.
Equivalency domains which partition a fabric for locational or abstract purposes and contain equivalency and comparison activities within.

It should be noted that the various software components described herein may be delivered as data and/or instructions embodied in various computer-readable media. Formats of files and other objects in which such software components may be implemented include, but are not limited to formats supporting procedural, object-oriented or other computer programming languages, as well as various linkable-object formats and executable-file formats. Computer-readable media in which such formatted data and/or instructions may be embodied include, but are not limited to, non-volatile storage media in various forms (e.g., optical, magnetic or semiconductor storage media).

When received within a computer system via one or more computer-readable media, such data and/or instruction-based expressions of the above described software components may be processed by a processing entity (e.g., one or more processors) within the computer system to realize the above described embodiments of the invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of determining memory equivalency between a plurality of computing systems coupled to one another via a communications network, the method comprising:
generating a first memory state value representative of contents of a first region of memory within a first computing system;
communicating the first memory state value from the first computing system to a second computing system via the communications network;
generating a second memory state value representative of contents of a second region of memory within the second computing system;
comparing the first and second memory state values; and
recording equivalency between the first and second regions of memory within a memory equivalency database based, at least in part, upon whether the first and second memory state values match.

2. The method of claim 1 further comprising identifying the first region of memory prior to generating the first memory state value.

3. The method of claim 1 wherein generating a first memory state value representative of contents of a first region of memory comprises generating a signature having fewer bits than necessary to represent all possible states of the first region of memory.

4. The method of claim 1 wherein recording equivalency between the first and second regions of memory within a memory equivalency database based, at least in part, upon whether the first and second memory state values match comprises:
generating a third memory state value representative of the contents of the first region of memory and a fourth memory state value representative of the contents of the second region of memory if the first and second memory state values match;
comparing the third and fourth memory state values; and
recording equivalency between the first and second regions of memory within the memory equivalency database if the third and fourth memory state values match.

5. The method of claim 4 wherein generating the first memory state value comprises generating a signature having a first number of bits and generating the third memory state value comprises generating a signature having a second number of bits, the second number being larger than the first number.

6. The method of claim 4 wherein generating the first and third memory state values comprises combining data values within the first region of memory according to respective first and second algorithms.

7. The method of claim 1 wherein the contents of the first region of memory comprises a first plurality of data values stored within respective storage locations, and the contents of the second region of memory comprises a second plurality of data values stored within respective storage locations, and wherein recording equivalency between the first and second regions of memory within a memory equivalency database based, at least in part, upon whether the first and second memory state values match comprises:
comparing each of the first plurality of data values with a respective one of the second plurality of data values if the first and second memory state values match; and
recording equivalency between the first and second regions of memory within the memory equivalency database if the each of the first plurality of data values matches the respective one of the second plurality of data values.

8. The method of claim 1 wherein communicating the first memory state value from the first computing system to the second computing system via the communications network comprises communicating the first memory state value from the first computing system to the second computing system using a standard internet protocol.

9. The method of claim 1 further comprising hosting a first operating system within the first computing system and hosting a second operating system within the second computing system.

10. The method of claim 1 further comprising communicating the first memory state value from the first computing system to a third computing system via the communications network.

11. The method of claim 10 further comprising generating a third memory state value representative of contents of a third region of memory within the second computing system, comparing the first and third memory state values, and recording equivalency of between the first and third regions of memory within the memory equivalency database based, at least in part, upon whether the first and third memory state values match.

12. The method of claim 11 further comprising invalidating the recording of equivalency between the first and third regions of memory within the memory equivalency database in response to detecting that the third computing system has been decoupled from the communications network.

13. The method of claim 1 further comprising storing the memory equivalency database in respective parts within a subset of the plurality of computer systems coupled to the communications network, wherein the subset of the plurality of computer systems comprises two or more of the plurality of computer systems.

14. The method of claim 1 further comprising accelerating transfer of data to a third computing system, including:
determining that data to be transferred to the third computing system comprises data within the first region of memory of the first computing system; and
transferring data within the second region of memory from the second computing system to the third computing system instead of transferring the data within the first region of memory.

15. The method of claim 14 wherein the data to be transferred to the third computing system comprises at least a portion of a virtual machine.

16. The method of claim 14 wherein the data to be transferred to the third computing system comprises at least a portion of a workload.

17. A system comprising:
a communications network;
a first computing system coupled to the communications network to generate a first memory state value representative of contents of a first region of internal memory of the first computing system and to output the first memory state value via the communications network; and
a second computing system coupled to receive the first memory state value via the communications network and to (i) compare the first memory state value with a second memory state value representative of contents of a second region of internal memory of the second computing system and (ii) record equivalency between the first and second regions of memory within a memory equivalency database based, at least in part, upon whether the first and second memory values match.

18. The system of claim 17 further comprising a third computing system coupled to the communications network and having at least a portion of the memory equivalency database stored thereon.

19. The method of claim 17 wherein the first computing system comprises network interface circuitry to output the first memory state value via the communications network in a communication according to a standard internet protocol.

20. A computer-readable medium carrying one or more sequences of instructions which, when executed by one or more processing units within a network of computing systems, cause the one or more processing units to:
generate a first memory state value representative of contents of a first region of memory within a first computing system;
communicate the first memory state value from the first computing system to a second computing system via the communications network;
generate a second memory state value representative of contents of a second region of memory within the second computing system;
comparing the first and second memory state values; and
record equivalency between the first and second regions of memory within a memory equivalency database based, at least in part, upon whether the first and second memory state values match.
